(19) United States
(12) Patent Application Publication
(10) Pub. No.: US 2026/0258678 A1
(43) Pub. Date: Sep. 3, 2026

(54) LOCK HOLDER FOR A MOTOR VEHICLE DOOR LOCK

(71) Applicant: Kiekert Aktiengesellschaft, Heiligenhaus (DE)

(72) Inventors: Ömer INAN, Dorsten (DE); Peter SZEGENY, Engelskirchen (DE); Holger SCHIFFER, Meerbusch (DE); Michael SCHOLZ, Essen (DE); Andreas SCHMITZ, Velbert (DE); Thorsten BENDEL, Oberhausen (DE); Michael HERRMANN, Neukirchen-Vluyn (DE)

(73) Assignee: Kiekert Aktiengesellschaft, Heiligenhaus (DE)

(21) Appl. No.: 18/881,916

(22) PCT Filed: Jun. 5, 2023
(86) PCT No.: PCT/DE2023/100424

§ 371 Date: Jan. 21, 2025

(30) Foreign Application Priority Data
Jul. 11, 2022 (DE) 10 2022 117 244.9

(51) Int. Cl. E05B 85/04

(52) U.S. Cl. CPC E05B 85/045; E05Y 2900/531

(57) ABSTRACT

The invention relates to a lock holder (1) for a motor vehicle door lock, having a lock holder plate (2) and a lock holder bracket (3) which is secured to the lock holder plate (2). The lock holder bracket (3) is formed with a locking pin (5), a central piece (6, 6′), and a connecting pin (7), and the lock holder bracket (3) is designed in at least two parts.

The invention relates to a lock holder for a motor vehicle door lock, having a lock holder plate and a lock holder bracket which is secured to the lock holder plate, wherein the lock holder bracket is formed with a locking pin, a central piece, and a connecting pin.

The lock holder generally interacts with a locking mechanism of an associated motor vehicle door lock. The lock holder and motor vehicle door lock generally define the motor vehicle door locking means. In conjunction with the locking mechanism in the motor vehicle door lock, the lock holder ensures a secure and reliable closure of the associated motor vehicle door. For this purpose, the lock holder is usually connected to a motor vehicle body, for example a B or C pillar of the associated motor vehicle body. The motor vehicle door lock, on the other hand, is located in the motor vehicle door to be locked. In principle, this can also be reversed.

Due to the primary closing function of the lock holder in conjunction with the locking mechanism in the motor vehicle door lock, this is, on the one hand, a particularly safety-relevant component which, on the other hand, is exposed to particular loads in particular in the event of an accident. In fact, the protection of vehicle occupants in the event of a side impact depends substantially on how reliably the lock holder and the locking mechanism interacting therewith are capable of absorbing the forces acting thereon. The primary concern here is that the motor vehicle door remains closed so that safety devices provided in or on the motor vehicle door, such as side airbags, side impact protection, etc., can have the desired effect.

The forces to be absorbed via the interaction between the motor vehicle door lock and the lock holder act directly between the locking mechanism contained in the motor vehicle door lock and the locking pin of the lock holder bracket which engages with the locking mechanism. The locking mechanism is formed by a catch and at least one pawl, wherein after engagement of the catch, during a closing movement of the door element, the pawl engages in the catch in the striker of the lock holder and prevents the door element from opening.

The locking mechanism may have a pre-ratchet and a main ratchet which can be present in the door lock depending on the door element. Depending on the embodiment of the locking mechanism, the particular catch position, i.e., main ratchet or pre-ratchet, can be provided with an opening or closing moment, so that a blocking lever can be used to secure the catch position. In order to be able to absorb the high forces that occur in the event of an accident, the locking mechanism parts are made at least in part from a metal material, mounted in metal shafts and held on a metal lock plate in the vehicle door lock.

In the prior art, various approaches have already been pursued to further develop such lock holders so that they can absorb far more forces than before in the event of a crash, without tearing off or general mechanical damage occurring or being able to occur. In fact, with regard to the lock holder, material deformations and tears are often observed in practice, in particular at the transition from the lock holder bracket to the lock holder plate.

In order to increase the forces which can be absorbed by the lock holder, various approaches have become known. There are various approaches to providing the lock holder or its lock holder bracket with different cross-sectional thicknesses, as described for example in EP 2 031 158 A2, or to specify an elongation of the lock holder by means of an indentation, as disclosed for example in DE 10 2010 021 677 A1. However, this does not adequately reflect the loads which actually occur in practice and the associated deformation behavior of the lock holder in the event of a crash or extreme forces. It has become apparent that the connection between the lock holder bracket and the lock holder plate is particularly important.

DE 10 2014 006 857 A1 discloses a lock holder for a motor vehicle door lock, which lock holder has a lock holder plate and a lock holder bracket attached thereto, wherein the lock holder bracket is designed with a locking pin, a central piece and a connecting pin. To strengthen the connection between the lock holder bracket and the lock holder plate, the publication proposes that the lock holder bracket be positively connected to the lock holder plate via at least one material-thickened region. To ensure a positive connection, the part of the lock holder bracket or the locking pin and/or the connecting pin which protrudes beyond the lock holder plate is compressed. As a result of the compression process, the lock holder plate is also provided with a bulge which ensures that compression caps created on the underside of the lock holder plate as a result of the compression process can abut at a distance from the locking pin on the one hand and the connecting pin on the other hand in relation to the body.

The solutions known from the prior art have generally proven themselves, but are reaching their limits with newer developments in the automotive industry. The use of batteries in hybrid or electric vehicles increases the weight of the vehicles and therefore the loads arising in the event of an accident. The batteries present in the motor vehicle increase the total weight of the vehicle many times over so that the loads on the locking mechanism and the lock holder in the event of an accident are also increased. Consequently, approaches must be found to increase the strength of the lock holder. This is where the invention comes in.

The object of the invention is to provide an improved lock holder for a motor vehicle door lock. In particular, it is an object of the invention to improve the load capacity of the lock holder and to increase the tear resistance of the system consisting of the lock and the lock holder.

According to the invention, the object is achieved by the features of independent claim 1. Advantageous embodiments of the invention are specified in the dependent claims. It should be noted, however, that the embodiments described below are not restrictive; rather, any variation of the features described in the description and the dependent claims is possible.

According to claim 1, the object of the invention is achieved in that a lock holder for a motor vehicle door lock is provided, having a lock holder plate, a lock holder bracket which is secured to the lock holder plate, wherein the lock holder bracket is formed with a locking pin, a central piece and a connecting pin, and wherein the lock holder bracket is formed in at least two parts. The design according to the invention of the lock holder now makes it possible to design the lock holder bracket so that it can be individually adapted to the loads and, in particular, to the extreme loads in the event of an accident. The individual loads in the event of an accident are particularly relevant to safety, as it must be ensured that the doors, flaps or hoods remain closed, in particular in the event of an accident. The side doors are particularly important because the occupants of the motor vehicle must be protected. Other safety systems, such as brake assist, seat belts and airbags, can only be fully effective when the door is securely closed.

The loads during a crash are extremely high and are simulated by tensile tests when designing the lock holder. The lock holder is subjected to a tensile test until it breaks in order to determine whether the defined specifications are met and to identify weak points so that the lock holder can be designed individually. In particular, this is where the invention comes in and shows a way to improve the load capacity of the lock holder.

As already indicated above, the lock holder according to the invention not only relates to a side door, but can also be used in the region of a hood, tailgate, sliding door, cover, foldable seats, etc., in other words wherever components used on the motor vehicle in a pivoting or sliding manner must be held securely in their position.

Basically, the lock holder has a lock holder plate which is designed as a base for the lock holder bracket and which preferably has at least two boreholes by means of which the lock holder can be secured to the motor vehicle or to the movable component. The openings in the lock holder plate preferably have a conical countersink so that a flat surface with the lock holder plate can be achieved by means of suitable screws having a conical head. The lock holder plate can additionally have a bevel so that the rivet heads of the lock holder bracket can be accommodated in the bevel so that, in turn, at least a partial region of the lock holder plate can be secured flat to the body. The bevel then accommodates the corresponding rivet heads of the lock holder bracket.

The lock holder bracket should preferably be divided into three regions having different functions. Starting from a locking pin, the lock holder bracket has a central piece and a connecting pin. The locking pin is the part of the lock holder bracket that engages with the locking mechanism and in particular the catch. In other words, when closing a side door, for example, the catch engages with a locking pin attached to the motor vehicle and is rotated by means of the interaction and a relative movement between the locking pin and the catch so that the catch can reach its catch position. The locking pin is preferably secured to the lock holder plate at a right angle, i.e., in the direction of a normal to the lock holder plate. Starting from the striker, the central piece extends substantially parallel to the lock holder plate, thereby creating an engagement region for the catch in the locking pin. The central piece is followed by the connecting pin, which in turn extends from the central piece to the lock holder plate. The connecting pin can be straight or, at least in regions, bent. A lock holder bracket designed according to the invention offers the possibility of individually reinforcing the locking pin, since the locking pin can be designed as a separate component to be adaptable to the requirements and in particular the loads in the event of an accident.

The lock holder bracket can be formed from a first part forming the locking pin and a second part forming the central piece and the connecting pin. In other words, the locking pin forms a separate component which interacts directly with the locking mechanism and which can be designed to be adapted to the interaction with the catch. In particular, the interaction between the catch and the locking pin is of substantial importance for the load capacity of the lock holder, since the force in the event of an accident or during a tensile test is transmitted via the locking pin to the catch or the locking mechanism, or vice versa.

It may also be advantageous if the locking pin has a substantially cylindrical shape and is preferably designed as a lock holder pin. A cylindrical basic shape of the locking pin allows easy interaction between the catch and the locking pin. The catch has a standard design with an inlet mouth, which is formed by a catch arm and a load arm. Catch arm because, when the catch first engages the locking pin, the catch arm engages with the locking pin, after which, when the catch is closed or locked in the main ratchet, the load arm interacts with the locking pin in such a way that the tensile force or, in the event of a crash, the holding force is transmitted via the load arm. The load arm as well as the catch arm are designed as stamped parts, which can have a plastic coating, but which have flat surfaces that interact with the locking pin. Thus, the cylindrical shape of the locking pin, which is present at least in the engagement region of the catch, allows easy engagement, turning and holding of the locking system.

It may also be advantageous if the central piece has a flattened region and the flattened region can be connected to the locking pin. A first part of the central piece, in particular the part of the central piece that is connected to the locking pin, thus serves as a contact surface for the locking pin, wherein an opening, in particular a borehole, can be made in the flattened region into which the locking pin can be inserted. If part of the locking pin extends through the opening in the flattened region, the locking pin can be riveted over the flattened region to create a secure and heavy-duty connection between the central piece and the locking pin. The locking pin is therefore permanently connected to the lock holder plate on one side and to the central piece on the opposite side by means of forming.

If the lock holder bracket has at least a material compaction, the load capacity can be increased and thus the safety in the motor vehicle can be increased. The lock holder bracket, i.e., the locking pin, the central piece and the connecting pin, are connected to the lock holder plate as a bracket. Thickening the lock holder bracket in the region of the lock holder plate makes it possible to increase the load capacity of the lock holder bracket. By thickening the base region of the locking pin and, if applicable, the connecting piece, the contact surface on the mounting plate or the lock holder plate can be maximized. By maximizing the contact surface, the resistance to bending stress is increased. Bending stress can act on the locking pin in particular in the longitudinal direction of the vehicle or in the vertical direction. Typically, a coordinate system is placed in a motor vehicle for design purposes. The y-axis represents the longitudinal direction of the vehicle, the x-axis represents the transverse direction of the vehicle and the z-axis represents a vertical axis in relation to the motor vehicle or the ground below the vehicle. The bending stress can be increased in particular in the y-and z-directions.

In addition, the locking pin can have a material thickening in the connection region to the central piece. As already explained above, the material thickening can increase the contact surface between the locking pin and the central piece, in particular the flattened region of the central piece, so that the bending load capacity can be increased. The material thickening in the region of the central piece thus increases the bending load capacity. In addition, the material thickening can advantageously increase the contact surface when riveting the locking pin, so that an additional contact surface is available for riveting or forming.

According to the invention, the material thickening on the locking pin in the connection region to the central piece forms a contact surface for the catch. The load capacity of the lock holder bracket can be significantly increased as a result of the structure of the locking bolt according to the invention, which also provides a contact surface for the catch. As tests have shown, the installation of the catch results in a load distribution from the locking pin to the catch. Since the catch is not only engaged with the locking pin through the load arm, but rather, according to the invention, via the collar formed by the thickening, i.e., at least a partially circumferential contact of the catch with the locking pin, the force can be transmitted from the load arm to the catch arm. The load arm of the catch is relieved and the tensile strength in the x-direction, i.e., in the lateral direction of the motor vehicle, is improved.

If usually only the load arm rests on the locking pin, whereby the load arm grips around the locking pin, the contact surface between the catch and the locking pin can be converted into a lateral force transmission between the catch and the locking pin by means of the crash collar designed according to the invention. In other words, the catch also rests laterally on the crash collar, i.e., the thickening, which in particular increases the tear resistance. The crash collar or thickening can be designed as a flat contact surface on the locking pin.

It can also be advantageous if the central piece and the connecting pin are formed in one piece and from a wire. The one-piece design of the central piece and connecting pin offers the possibility of a cost-effective and at the same time precise production of the lock holder bracket. In particular, the two-part design of the lock holder bracket allows for individual adaptation to the engagement conditions between the catch and the lock holder bracket. The lock holder bracket can thus be individually reinforced in the region of interaction between the locking pin and the catch and additionally improve the force transmission between the catch and the lock holder bracket.

Depending on the requirements and design of the lock holder bracket, the central piece and the connecting pin can have a different geometric cross-sectional shape. If it is advantageous in the region of the connecting pin if the connecting pin has a circular cross-sectional shape, it can be advantageous in the region of the central piece if the central piece has a cross-sectional shape that can substantially be described as rectangular. In particular, the design of the cross-sectional shape allows the lock holder bracket to be individually adjusted to the loads occurring in the lock holder bracket. However, the space conditions in the interaction between the lock holder bracket and the motor vehicle lock can also play a role in the design of the cross-sectional shape of the central piece and connecting pin, since the space conditions in the motor vehicle lock are usually reduced. Thus, a flat shape of the central piece can advantageously influence the installation space in the motor vehicle lock, since a flat design of the central piece requires less space in the interaction between the motor vehicle lock and the central piece.

It can be stated that the individual design of the lock holder bracket makes it possible to adapt to the interaction between the catch and the locking pin, which in turn can increase the load capacity in the event of an accident. The individual design of the lock holder bracket allows for load distribution and also increases the tear resistance of the lock holder bracket.

In the following, the invention is explained in more detail with reference to the appended drawings using an embodiment. However, the principle applies that the embodiment does not limit the invention, but is merely an advantageous embodiment of the invention. The features depicted can be implemented individually or in combination with further features of the description as well as what is claimed-individually or in combination.

In the figures:

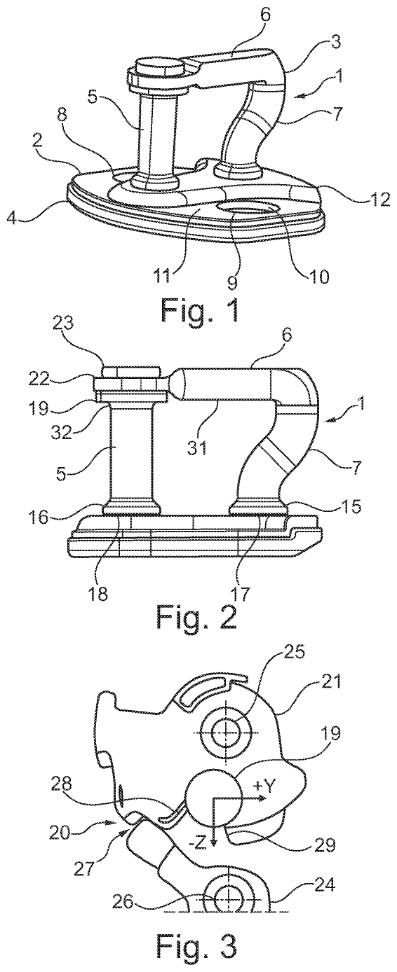

FIG. 1 shows a three-dimensional view of a lock holder designed according to the invention, with a plastic base, a lock holder plate and a lock holder bracket,

FIG. 2 shows a side view of the lock holder designed according to the invention as shown in FIG. 1,

FIG. 3 shows a schematic representation of a locking mechanism in interaction with the locking pin and in particular the crash collar of the locking pin,

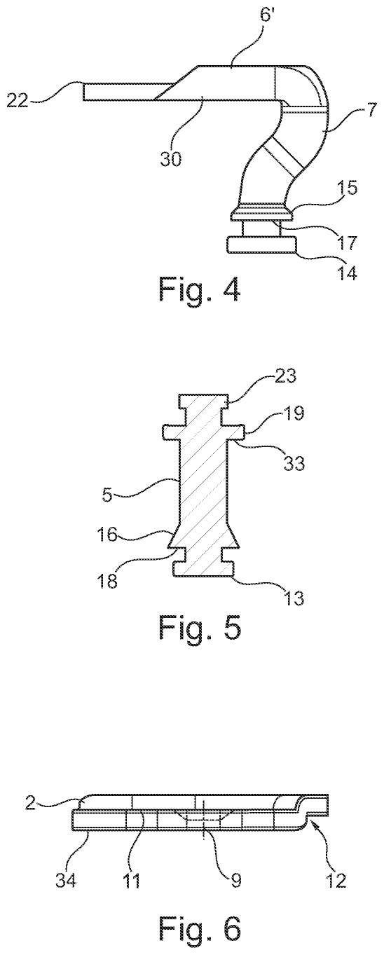

FIG. 4 shows a detailed view of the central piece and the connecting pin as a separate component,

FIG. 5 shows a separate representation of the locking pin designed according to the invention, and

FIG. 6 shows a separate representation of the lock holder plate in a side view.

FIG. 1 shows a lock holder 1 in a three-dimensional view consisting of a lock holder plate 2, a lock holder bracket 3 and a plastic base 4. The lock holder bracket 3 has a locking pin 5, a central piece 6 and a connecting pin 7. In this embodiment, the lock holder bracket 3 is made in two parts from a separate locking pin 5 and a separate one-piece central piece 6 with connecting pin 7.

The lock holder plate 2 has through holes, which additionally include a countersink 10. By means of the boreholes, it is possible to connect the lock holder 1 to a body and by means of screws. By selecting suitable screws, for example with a countersunk head, a flat surface can be achieved with the surface 11 of the lock holder plate 2. In addition, the lock holder plate 2 has a bevel 12, which allows rivet heads 13, 14, which will be described below, to be arranged at a distance from the motor vehicle body, so that the lock holder plate 2 can be secured flatly to the motor vehicle body. In addition, a plastic base 4 is arranged around the lock holder plate 2 at least in some regions, wherein the plastic base can on the one hand represent a means for minimizing noise and on the other hand, for example, centering means can be formed on the plastic base 4.

FIG. 2 is a side view of the lock holder 1 as shown in FIG. 1. The thickenings 15, 16 on the locking pin 5 and on the connecting pin 7 are clearly visible, whereby an increase in the contact surface on the lock holder plate 2 can be achieved. Furthermore, a thickening in the form of a crash collar 19 is formed on the locking pin 5, whereby on the one hand the contact surface on a locking mechanism 20 and in particular a catch 21 can be increased. The locking pin 5 is connected to a flattened region 22 of the central piece 6, wherein the locking pin 5 is connected by means of riveting to obtain a rivet head 23.

FIG. 3 shows a locking mechanism 20 in principle. The locking mechanism 20 consists of a catch 21 and a pawl 24. Both locking mechanism parts 21, 24 are each accommodated in a motor vehicle lock so as to be pivotable about an axis 25, 26. The main ratchet of the locking mechanism 20 is shown, with the pawl 24 and the catch 21 abutting against one another in a main ratchet position 27. The catch 21 has a catch arm 28 and a load arm 29. Also shown is a part of a coordinate system with the designations y and z. The catch 21 interacts with the locking pin 5, with the crash collar 19, as a thickening, lying at least partially around the circumference of the catch arm and load arm. It is clearly visible that the crash collar 19 or the thickening 19 on the locking pin 5 extends beyond the catch arm 28 and the load arm 29. Thus, the locking pin 5 is also able to absorb forces in the y- and z-directions.

FIG. 4 shows the central piece 6′ and the connecting pin 7. Identical components are provided with the same reference signs. If the central piece 6 is designed in accordance with the embodiments of FIGS. 1 and 2 such that the flattened region 22 extends approximately centrally from the central piece 6 to the locking pin 5, then in FIG. 4 the flattened region 22 is substantially flat, i.e., arranged on one side towards the flattened end 30 of the central piece 6′. Depending on the requirements of the lock holder 1, the central piece 6, 6′ can be individually adapted, whereby in accordance with the embodiment of FIGS. 1 and 2, an additional contact surface 31 for the load arm 29 can be provided by the central piece 6 and the flattened side 31.

In FIG. 5, the connecting pin 5 is shown as a separate component and detached from the lock holder bracket 3 and the lock holder plate 2. The rivet heads 13, 23 can be seen, which connect the locking pin 5 to the lock holder plate 2 and the flattened region 22. The thickening 16 allows an enlarged contact surface 18 and the crash collar 19 shown here enlarges the contact surface towards the catch 21 as well as towards the rivet head 23 or the flattened region 22 of the central piece 6, 6′. The locking pin 5 is substantially cylindrical and can have a radius 32 in the region towards the crash collar 19 or, as shown in FIG. 5, form a flat contact surface 33 towards the catch 21. The indentation 16 or thickening 16 can also be designed with sharp edges, as shown in FIG. 5.

FIG. 6 shows the lock plate 2 as a separate component. The bevel 12, which can represent a receptacle for the rivet heads 13, 14 of the locking pin 5 or the connecting pin 7, is clearly visible. This creates the possibility of connecting the lock holder plate 2 flatly to the body of a motor vehicle on a flat underside 34.

### LIST OF REFERENCE SIGNS

1 Lock holder
2 Lock holder plate
3 Lock holder bracket
4 Plastic base
5 Locking pin
6, 6′ Central piece
7 Connecting pin
8, 9 Borehole
10 Countersink
11 Surface
12 Bevel
13, 14, 23 Rivet head
14, 16, 17 Thickening
17, 18, 31, 33 Contact surface
19 Crash collar, thickening
20 Locking mechanism
21 Catch
22 Flattened region
24 Pawl
25, 26 Axis
27 Main ratchet
28 Catch arm
29 Load arm
30 End
32 Radius
Y, Z Load directions, coordinate system

1. A lock holder for a motor vehicle door lock, comprising:
a lock holder plate and a lock holder bracket,
wherein the lock holder bracket is secured to the lock holder plate,
wherein the lock holder bracket includes a locking pin, a central piece, and a connecting pin, and
wherein the lock holder bracket is designed in at least two parts.

2. The lock holder according to claim 1, wherein the locking pin is designed as a separate component.

3. The lock holder according to claim 1, wherein the at least two parts of the lock holder bracket comprises a first part including the locking pin and a second part including the central piece and the connecting pin.

4. The lock holder according to claim 1, wherein the locking pin has a cylindrical shape and the locking pin is designed as a lock holder pin that engages with a locking mechanism of a motor vehicle door lock.

5. The lock holder according to claim 1, wherein the central piece has a flattened region, and wherein in the flattened region is connected to the locking pin.

6. The lock holder according to claim 1, wherein the lock holder bracket has at least one material thickening.

7. The lock holder according to claim 6, wherein the locking pin has a respective one of the at least one material thickening in a respective connection region to the central piece.

8. The lock holder according to claim 6, wherein a respective one of the at least one material thickening forms a contact surface for a catch of the motor vehicle door lock.

9. The lock holder according to claim 1, wherein the central piece and the connecting pin are formed in one piece and from a wire.

10. The lock holder according to claim 1, wherein the central piece and the connecting pin have a different geometric cross-sectional shape.

11. The lock holder according to claim 1, wherein the locking pin is permanently connected to the lock holder plate on a first side and permanently connected to the central piece on an opposite side relative to the first side.

12. The lock holder according to claim 1, wherein the lock holder plate includes a conical countersink and a bevel for accommodating the lock holder bracket.

13. The lock holder according to claim 1, wherein the locking pin is secured to the lock holder plate at a right angle in a direction normal to the lock holder plate.

14. A motor vehicle door lock comprising:
the lock holder according to claim 1, and
a catch,
wherein the catch comprises an inlet mouth, wherein the inlet mouth includes a catch arm and a load arm.

15. The motor vehicle door lock according to claim 14, wherein the lock holder bracket has at least one material thickening, and wherein a respective one of the at least one material thickening forms a contact surface for the catch.

16. The motor vehicle door lock according to claim 14, wherein the central piece extends parallel to the lock holder plate to create an engagement region for the catch in the locking pin.
